(19) United States
(12) Patent Application Publication
(10) Pub. No.: US 2026/0359089 A1
(43) Pub. Date: Nov. 12, 2026

(54) COORDINATED SCHEDULING OF APPLICATIONS IN VIRTUALIZED ENVIRONMENT HOSTED BY TSN ENTITY

(71) Applicant: Telefonaktiebolaget LM Ericsson (publ), Stockholm (SE)

(72) Inventors: Dhruvin PATEL, AACHEN (DE); Joachim SACHS, SOLLENTUNA (SE); János FARKAS, KECSKEMÉT (HU); János HARMATOS, Budapest (HU); Balázs VARGA, Budapest (HU); Marilet DE ANDRADE JARDIM, KISTA (SE); György MIKLÓS, PILISBOROSJENÖ (HU)

(73) Assignee: Telefonaktiebolaget LM Ericsson (publ), Stockholm (SE)

(21) Appl. No.: 19/153,605

(22) PCT Filed: Feb. 15, 2023
(86) PCT No.: PCT/SE2023/050134

§ 371 Date: Aug. 5, 2025

(51) Int. Cl. G06F 9/455; G06F 9/48; G06F 9/50

(52) U.S. Cl. CPC G06F 9/45558; G06F 9/4881; G06F 9/5077; G06F 2009/4557; G06F 2009/45595

(57) ABSTRACT

Embodiments of the present disclosure provide a method (400) for scheduling a plurality of applications (10a-10n) for execution in a virtualized environment (50) resident on a computing device (60). The computing device (60) being operated as a Time-Sensitive Networking, TSN, entity for a TSN system (100), the TSN system (100) being integrated to a wireless communication network (90). The method is performed within the virtualized environment (50) by the computing device (60). The method (400) comprises obtaining (402) deterministic characteristics for each application of the plurality of applications comprising one or more instances and configuration information related to a plurality of resources (30a-30n) of the computing device (60) for execution of the plurality of applications (10a-10n). The method (400) comprises allocating at least some resources from the plurality of resources to each of the plurality of applications based on the deterministic characteristics and the configuration information. The method (400) comprises scheduling (406) the plurality of applications (10a-10n) on the plurality of resources in accordance with the allocation.

Corresponding computing device, and computer program products are also disclosed.

### TECHNICAL FIELD

The present disclosure relates generally to the field of Time-Sensitive Networking, TSN, systems. More particularly, it relates to method, computing device, and computer program products for scheduling applications for execution in a virtualized environment resident on a computing device, wherein the computing device is operated as an entity for a TSN system.

### BACKGROUND

An automation industry is undergoing a digital transformation towards the “Fourth Industrial Revolution” (Industry 4.0), which involves smart manufacturing. The automation industry provides flexible connectivity infrastructure, which is a key enabler for manufacturing to interconnect machines, products, and all kinds of other devices in a flexible, secure, and consistent manner.

Communication technology enablers for the digital transformation of the automation industry are Time Sensitive Networking, TSN, system (TSN network) on a wireline side, and a Third Generation Partnership Project, 3GPP, Fifth Generation, 5G, network on a wireless side. The TSN system is based on the Institute of Electrical and Electronics Engineers, IEEE 802.1 and 802.3 standard. The TSN system provides deterministic services with time synchronization, guaranteed low latency transmissions and high reliability. The 5G network, an alternative to a wired connectivity solution supports communication with unprecedented reliability and very low latency, as well as massive Internet of Things, IoT, connectivity. Thus, the TSN system and the 5G network are considered as complementary technologies in providing the deterministic communication services, thereby paying the way towards future advanced manufacturing systems and other vertical areas. In addition, the TSN system and the 5G network are essential for network convergence that is a support of all kinds of communication services via a same network infrastructure. Therefore, the TSN system can be integrated to the 5G network for supporting the deterministic/time sensitive communication services over heterogeneous infrastructure and multiple application domains essential for the network convergence.

FIG. 1A discloses an example existing implementation a TSN system 100 integrated to a 5G network. With the integration of the TSN system 100 to the 5G network, the 5G network is deployed as a set of IEEE complainant virtual TSN bridges, for example, a virtual TSN bridge 80, as depicted in FIG. 1A. The virtual TSN bridge 80 can be connected to TSN bridge(s) 70. The TSN system 100 comprises a Centralized Network Controller, CNC, 90 and a Centralized User Configuration, CUC 95, for configuring and controlling operations of the TSN bridge 70 and the virtual TSN bridge (5G-TSN entities) 80.

The TSN system 100 further comprises a computing device 60, as depicted in FIG. 1A. The computing device 60 can be operated as an entity for the TSN system 100. For example, the entity can be a TSN end station. Examples of the TSN end station may include, but are not limited to, robots, Automated Guided Vehicles, AGVs, with omni-wheels, excavators, or any other robotic devices. The TSN end station may also be connected to the UEs associated with the virtual TSN node 80.

The computing device 60 can host an application for performing one or more tasks such as, industrial motion control, robot control, or the like. The computing device 60 comprises a controller (for example, a hardware-based controller) to execute the application. In an example herein, the application may have deterministic service requirements that involve time synchronization, low latency, and high reliability. The controller executes the application. The application software obtains dedicated resources, and the application software and the hardware are tightly integrated and by sharing some of a plurality of resources such as, a computer, a network, a memory, storage, processes in an Operating System, OS, and so on, of the computing device 60 to the application. Thereby, guaranteeing deterministic service requirements.

In some implementations of the TSN system 100, the computing device 60 can host a virtualized environment to execute a plurality of applications, each application comprising one or more instances. However, in such a scenario, an effect of shared resource usage of compute and network domains, as well as OS kernel level treatment of network entities within the virtualized environment for executing the one or more applications can cause uncertainty in execution.

FIG. 1B discloses an example implementation of a TSN system 100 integrated to a 5G network, wherein a computing device 60 operating as a TSN entity for the TSN system hosts a virtualized environment 50.

As depicted in FIG. 1B, the computing device 60 hosts the virtualized environment 50 for execution of a plurality of applications, each application comprises one or more instances. Execution of the applications in the virtualized environment 50 (for example, executing at least an instance of the application on a network entity, like container) enables to utilize generic advantages of the virtualized environment 50 such as dynamic and elastic resource handling and scaling, flexible, adaptive application deployment management, robustness, and so on. Further, features of the virtualized environment 50 supporting edge computing can provide reduced latency between client and server applications, which further enables virtualization/cloudification of applications with low latency requirements, for example, industrial motion control, robot control, and so on.

The computing device 60 schedules the plurality of applications for execution within the virtualized environment by sharing resources among the plurality of applications. The resources can include network entities within the virtualized environment (such as containers, virtual interfaces, virtual switches, or the like). Nowadays, the computing device 60 typically shares the resources among the plurality of application based on a fair scheduling paradigm. However, such type of resource sharing may be suitable only for the applications, which do not have deterministic service requirements. Whenever the resource sharing based on the fair scheduling paradigm is used for execution of the applications having the deterministic service requirements, there may be degradation in performance of the applications as different instances of the application can influence each other.

### SUMMARY

If the deterministic service requirements of the applications have to satisfied, while execution of the applications in the virtualized environment, it is not enough to properly configure the TSN, and 5G-TSN entities, but characteristics related to the virtualized environment and an effect of virtualization have to be considered.

Consequently, there is a need for an improved method and arrangement of coordinated scheduling and resource allocation for the plurality of applications for executions in the virtualized environment hosted by the TSN entity that alleviates at least some of the above-cited problems.

It is therefore an object of the present disclosure to provide a method, a computing device, and a computer program product for scheduling a plurality of applications for execution within a virtualized environment hosted by a TSN entity, to mitigate, alleviate, or eliminate all or at least some of the above-discussed drawbacks of presently known solutions.

This and other objects are achieved by means of a method, a computing device, and a computer program product as defined in the appended claims. The term exemplary is in the present context to be understood as serving as an instance, example or illustration.

According to a first aspect of the present disclosure, a method for scheduling a plurality of applications for execution in a virtualized environment resident a computing device is provided. The computing device is operated as an entity for a TSN system. The TSN system is integrated to a wireless communication network. The method is performed within the virtualized environment by the computing device. The method comprises obtaining deterministic characteristics for each of the plurality of applications comprising one or more instances and configuration information related to a plurality of resources of the computing device for execution of the plurality of applications. The method comprises allocating at least some resources from the plurality of resources to each of the plurality of applications based on the deterministic characteristics and the configuration information. The method comprises scheduling the plurality of applications on the plurality of resources in accordance with the allocation.

In some embodiments, the plurality of resources comprises one or more of: network resources being implemented within the virtualized environment and computing resources of the computing device.

In some embodiments, the step of allocating at least some resources from the plurality of resources to each of the plurality of application comprises dividing the plurality of applications into groups, each group comprising at least one application, according to the deterministic characteristics for each of the plurality of applications. The method comprises selecting at least some resources from the plurality of resources for each group of applications. Based upon the selection, the method comprises allocating at least some resources from the plurality of resources for each group of applications.

In some embodiments, the step of selecting at least one some resources from the plurality of resources for each group of applications comprises associating namespaces of a kernel in the computing device to the groups of applications. The method comprises identifying, for each namespace, the deterministic characteristics for the associated group of applications. The method comprises selecting, based on the deterministic characteristics and the configuration information, at least some resources for each of the namespaces.

In some embodiments, the deterministic characteristics obtained for each application comprises one or more of: time sensitive characteristics for each application, latency and timeliness characteristics for each application, priority characteristics for each application, and reliability requirements for each application.

In some embodiments, the configuration information related to the plurality of resources comprises one or more of: information about amount of the plurality of resources, information about availability of the plurality of resources, and latency information related to the plurality of resources.

In some embodiments, the step of scheduling the plurality of application comprises identifying groups of applications, and a namespace associated with group of applications. The method comprises determining at least some resources allocated for each group of applications according to the namespace associated with each group of applications. The method comprises scheduling each group of applications on the determined at least some resources for execution in the virtualized environment.

In some embodiments, the method further comprises monitoring execution of the scheduled plurality of applications in the virtualized environment. Based on the monitoring, the method comprises determining degradation in performance of the at least one application of the plurality of applications. The method comprises modifying allocation of the at least some resources for the at least one application upon determining degradation in performance of the at least one application. The method comprises scheduling the at least one application in accordance with the modified allocation.

According to a second aspect of the present disclosure, a computing device for scheduling a plurality of applications for execution in a virtualized environment resident on the computing device is provided. The computing device is operated as an entity for a TSN system. The TSN system is integrated to a wireless communication network. The computing device is adapted for obtaining deterministic characteristics for each of the plurality of applications comprising one or more instances and configuration information related to a plurality of resources of the computing device for execution of the plurality of applications. The computing device is adapted for allocating at least some resources from the plurality of resources to each of the plurality of applications based on the deterministic characteristics and the configuration information. The computing device is adapted for scheduling the plurality of applications on the plurality of resources in accordance with the allocation.

According to a third aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for coordinated scheduling of the plurality of applications for execution in the virtualized environment resident on the computing device being operated as the TSN entity for the TSN system.

An advantage of some embodiments is that at least some resources is allocated for each of the plurality of applications for scheduling by dividing the plurality of application into groups, associating the namespace of the kernel to each group of applications, and allocating at least some resources to each namespace. Thus, at least some resources may be allocated by ensuring kernel namespace separation between different (types and instances of) applications by eliminating harmful interferences among each other.

An advantage of some embodiments is that at least some resources is allocated to each namespace based on the deterministic characteristics identified for the associated group of applications and the configuration information related to the plurality of resources. Thus, resulting coordinated allocation of resources for scheduling, which further results in coordinated scheduling of the applications.

An advantage of some embodiments is that coordinated scheduling of the applications in the virtualized environment may guarantee deterministic service requirements for the applications that involve precise end-to-end (E2E) timeliness, time synchronization, low latency and high reliability.

An advantage of some embodiments is that due to coordinated scheduling of the plurality of applications for execution in the virtualized environment, the plurality of applications do not need to wait in a queue for the resources. As a result, the applications may be executed within the virtualized environment without any delay.

An advantage of some embodiments is that due to coordinated scheduling of the plurality of applications for execution in the virtualized environment, packets generated during execution of the applications may be received at a physical interface/Ethernet port within a time interval configured by a Centralized Network Controller, CNC, of the TSN system. Thus, guaranteeing precise E2E timeliness requirements of the applications.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1A discloses an example existing implementation of a Time Sensitive Networking, TSN, system integrated to a wireless communication network;

FIG. 1B discloses an example implementation of a TSN system integrated to a wireless communication network, wherein a computing device operating as a TSN entity hosts a virtualized environment;

FIG. 2A discloses a TSN system integrated to a wireless communication network according to some examples;

FIG. 2B discloses a TSN system integrated to a wireless communication network, wherein a computing device operating as a TSN entity hosts a virtualized environment for coordinated scheduling of a plurality of applications according to some examples;

FIG. 3 discloses a computing device for coordinated scheduling of a plurality of applications within a virtualized environment according to some examples;

FIG. 4 is a flowchart illustrating example method steps according to some examples;

FIG. 5 is a schematic block diagram illustrating an example apparatus according to some examples; and

FIG. 6 discloses a computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

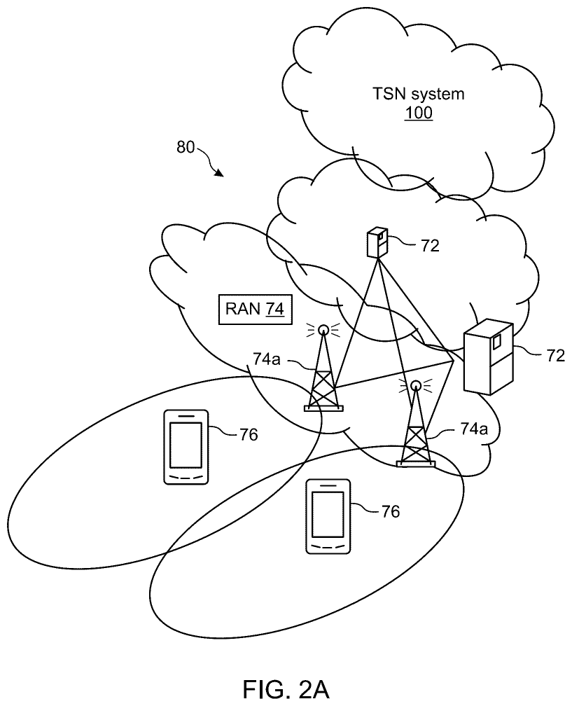

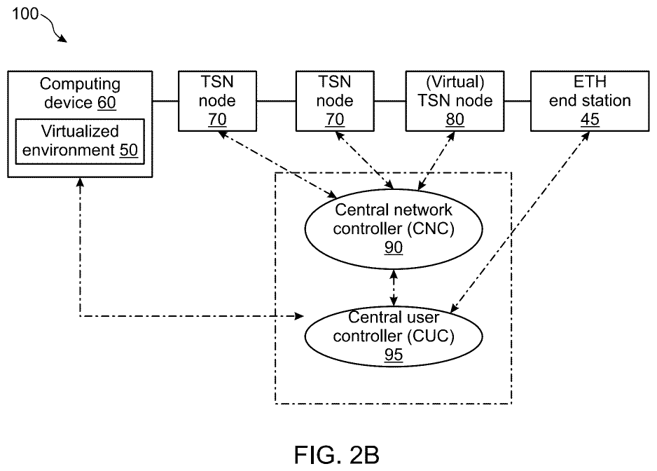

FIG. 2A discloses an example Time-Sensitive Networking, TSN, system 100 integrated to a wireless communication network 80. The TSN system 100 (also be referred to as TSN network) referred herein may be based on the Institute of Electrical and Electronics Engineers, IEEE 802.3 Ethernet standard. The TSN system 100 is integrated to the wireless communication network 80 to provide converged communication on a same network infrastructure for a wide range of applications that have deterministic service requirements (also be referred to as time sensitive requirements, futuristic service requirements, or the like). The deterministic service requirements may refer to provide communication service with guaranteed time synchronization/precise end-to-end, E2E, timeliness, high reliability, and low latency.

The wireless communication network 80 (also be referred to wireless communication system, cellular communication network/system, or the like) may be a wireless network, for example, a Fifth Generation, 5GS, network, a Long Term Evolution, LTE, network, an Evolved Universal Terrestrial Radio Access Network, E-UTRAN, a Wideband Code Division Multiple Access, WCDMA, network, a Global System for Mobile communications, GSM, network, a Worldwide Interoperability for Microwave Access, WiMAX, or any other future generation network.

The wireless communication network 80 may comprise a Radio Access Network, RAN, 74 and a core network, CN 72. The wireless communication network 80 may use a number of different Radio Access Technologies, RATs, such as LTE, LTE-Advanced, 5G, WCDMA, GSM/Enhanced Data rate for GSM Evolution, EDGE, WiMAX, Ultra Mobile Broadband, WMB, or the like.

The RAN 74 may comprise one or more network nodes 74a, each providing radio coverage over one or more geographical areas, such as cells supporting the one or more RATs. In some examples, the network node 74a may be a radio access node such as a radio network controller, an access point such as a Wireless Local Area Network, WLAN, access point or an Access Point Station, AP STA, an access controller, a base station, a base transceiver station, an Access Point base station, a base station router, a transmission arrangement of a radio base station, a standalone access point, or any other unit of the RAN capable of serving one or more User Equipments, UEs 76 in the cell/service area. Examples of the base station may include, a gNodeB, gNB, an evolved Node B, eNB, and so on.

The CN 72 may comprise a core network node. The core network node may be configured to communicate with the network node 74a via an interface, for example, an S1 interface. Example of the core network node may include User Plane Function, UPF.

In the wireless communication network 80, the one or more UEs 76 may communicate with the CN 72 via the network nodes 74a of the RAN 74. Examples of the UE 76 may include, a wireless device, a mobile station, a non-access point, non-AP, station, STA, a wireless terminal, or the like. It should be understood by those skilled in the art that “wireless device” is a non-limiting term, which means any terminal, a wireless communication terminal, a User Equipment, a Mobile Type Communication, MTC, device, a Device to Device, D2D, terminal, or a node for example, a smart phone, a laptop, a mobile phone, a sensor, a relay, a mobile tablet, or even a base station communicating within the cell.

The UE 76 (also be referred to as first end station) may be connected to one or more TSN entities, for example, TSN end stations (referred to as second end station). The second end station may include, but are not limited to, robots, Automated Guided Vehicles, AGVs, with omni-wheels, excavators, or any other robotic devices.

With the integration of the TSN system 100, the wireless communication network 80 may operate as a TSN virtual node (also be referred to as TSN virtual bridge, virtual wireless bridge, or the like).

FIG. 2B discloses an example TSN system 100 integrated to the wireless communication network 80, wherein a computing device 60 being operated as a TSN entity for the TSN system 100 hosts a virtualized environment 50.

As depicted in FIG. 2B, the TSN system 100 being integrated to the wireless communication network may comprise TSN bridges 70, a virtual TSN bridge 80, a TSN end station 45, and the computing device 60. In some examples, the TSN bridges 70, the virtual TSN bridge 80, the TSN end station 45, and the computing device 60 may be configured in a static configuration setup or a centralized network configuration setup. In the static configuration setup, the TSN bridges 70, the virtual TSN bridge 80, the TSN end station 45, and the computing device 60 may be configured during network setup. In the centralized network configuration setup, a Centralized Network Controller, CNC, 90 (also be referred to as centralized network configuration, TSN controller, or the like) may configure the TSN bridges 70, the virtual TSN bridge 80, the TSN end station 45, and the computing device 60 for TSN streams to be exchanged between each other. The CNC 90 may be adapted for configuring network resource reservations for the TSN bridges 70, the virtual TSN bridge 80, and the computing device 60. The CNC 90 may also be adapted for coordinating any changes to the configured network resource reservations with any new reservations. The network resource reservations may be made or requested by the TSN end station 45 and/or the computing device 60. In the fully centralized network configuration setup where both network and user configuration are centralized, the CNC 90 may receive requirements of data flows from a Centralized User Controller, CUC, 95 (also be referred to as centralized user configuration) and then compute a route, and a time schedule for end-to-end, E2E, transmission for each TSN stream. The CNC 90 may also configure the TSN bridges 70, the virtual TSN bridge 80, and the computing device 60 in accordance with the computed route and time schedule.

The TSN bridges 70 (also be referred to as TSN node, TSN wired bridge) may be wired TSN nodes. In some examples, the virtual TSN bridge 80 (also be referred to as virtual TSN node, TSN wireless node) may be the wireless communication network. In some examples, the virtual TSN bridge 80 may be a node implemented by the wireless communication network.

The TSN end station 45 may be configured to exchange time sensitive communication with another TSN end station through the TSN bridges 70 and the virtual TSN bridge 80. The time sensitive communication may comprise TSN streams or TSN packets or TSN flows to be exchanged between the TSN end stations. Examples of the TSN end station 45 may include, but are not limited to, robots, Automated Guided Vehicles, AGVs, with omni-wheels, excavators, or any other robotic devices. The TSN end station 45 may also be connected to the UEs associated with the virtual TSN node 80.

The computing device 60 is operated as an entity (also be referred to as TSN entity) for the TSN system 100. In some examples, the TSN entity may be the TSN end station. In some examples, the TSN entity may be a computing device coupled to the TSN end station.

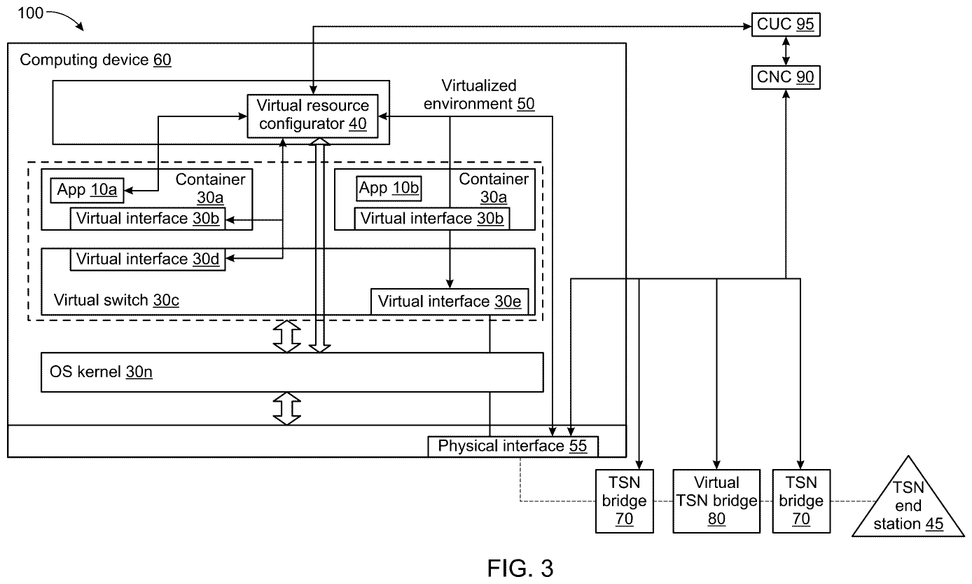

The computing device 60 hosts a virtualized environment 50. In some examples, the virtualized environment 50 may be a cloud-computing environment. The computing device 60 may support implementation of applications and network entities/network resources for execution of the applications in the virtualized environment 50. Examples of the network resources may include, but are not limited to, containers, virtual interfaces for containers, virtual switches, virtual interfaces for the virtual switches, and so on. The network resources are described in detail in conjunction with FIG. 3.

The plurality of applications referred herein may include for example, but are not limited to, industrial control applications, robotic applications, and so on. In some examples, each application of the plurality of applications may comprise one or more instances being executed on at least one first network resource, for example, at least one container in the virtualized environment 50. The one or more instances of the application may be a copy of the application, which may be executed on one or more containers within the virtualized environment 50. As would be understood, execution of the application may refer to execution of the one or more instances of the application and associated packages (for example, libraries) on the at least one container.

In some examples, at least one application of the plurality of applications may have different deterministic service requirements and other applications may not have any service requirements (which may be referred to as best effort services). Examples of the deterministic service requirements may include, guaranteed time synchronisation, precise end-to-end, E2E, timeliness, high reliability, low jitter, and low latency.

The computing device 60 may also provide computing resources for the network resources for execution of the applications in the virtualized environment. Hereinafter, the network resources/network entities and the computing resources may be collectively referred to as resources of the computing device 60.

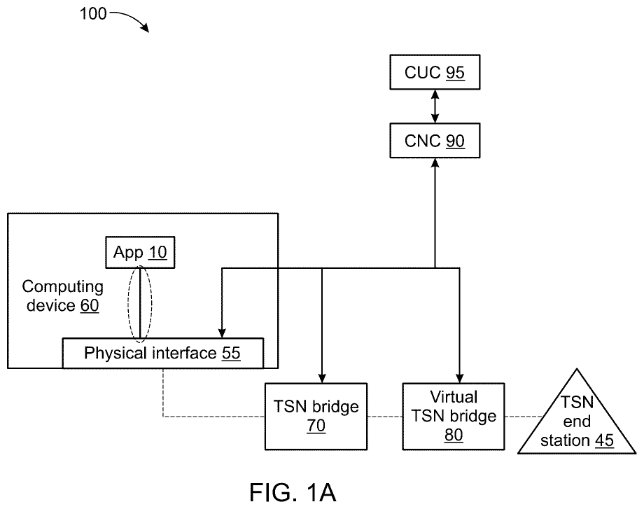

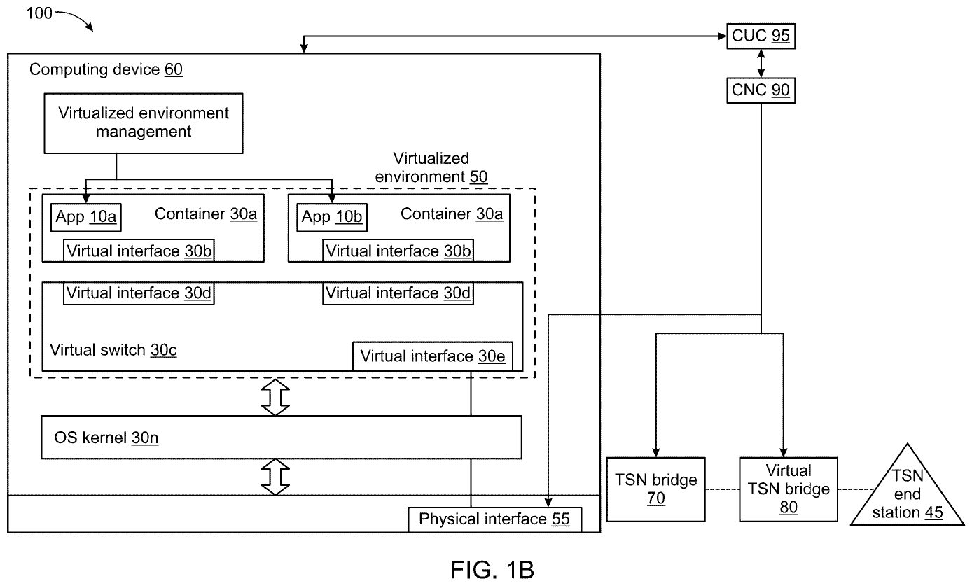

The computing device 60 is configured to schedule the plurality of applications for execution in the virtualized environment 50. In some existing implementations (as disclosed in FIG. 1B), the computing device 60 schedules the plurality of applications for execution in the virtualized environment 50 by dividing the resources among the plurality of applications according to a fair scheduling paradigm. However, such type of scheduling may be suitable only for best effort services, but not for the applications that have deterministic service requirements, since the fair scheduling paradigm cannot guarantee that there will no deteriorative resource interference between the applications. As a result, the applications may be executed in the virtualized environment with degraded performance and without satisfying the associated deterministic service requirements.

Therefore, according to some embodiments of the present disclosure, the computing device 60 implements a method within the virtualized environment 50, for coordinated scheduling of the plurality of applications for execution within the virtualized environment.

The computing device 60 obtains deterministic characteristics for each application of the plurality of applications comprising one or more instances and configuration information related to the plurality of resources of the computing device 60 for execution of the plurality of applications. In some examples, the deterministic characteristics obtained for each application identify the deterministic service requirements of the application. In some examples, the configuration information may comprise information about deployment details, availability, and latency of the plurality of resources. The plurality of resources may include the network resources being implemented within the virtualized environment and the computing resources of the computing device 60.

Based on the deterministic characteristics and the configuration information, the computing device 60 allocates at least some resources from the plurality of resources to each of the plurality of applications. In accordance with the allocation, the computing device 60 schedules the plurality of applications on the plurality of resources for execution within the virtualized environment 50. Thus, resulting in coordinated resource allocation and scheduling of the plurality of applications, which ensures execution of the applications in the virtualized environment 50 by achieving the deterministic service requirements of the applications.

Various examples for scheduling the plurality of applications for execution in the virtualised environment are explained in conjunction with figures in the later parts of the description.

FIG. 3 discloses the computing device 60 for coordinated scheduling of the plurality of applications within the virtualized environment 50. The computing device 60 operates as a TSN entity (for example, as a TSN end station) for the TSN system 100. The computing device 60 may be connected to one or more TSN bridges 70 and the CUC 95 of the TSN system 100.

The computing device 60 hosts the virtualized environment 50 for execution of a plurality of applications 10a-10n, each comprising one or more instances. In some examples, the virtualized environment 50 may be a cloud-computing environment. The plurality of applications 10a-10n may be executed by utilizing generic advantages of the virtualized environment such as dynamic and elastic resource handling and scaling, flexible, adaptive application deployment management, robustness, and so on. In some examples, the plurality of applications 10a-10n may include, but are not limited to, robotic applications, industrial control applications, and so on.

The computing device 60 may provide a plurality of resources 30a-30n for execution of the plurality of applications 10a-10n in the virtualized environment 50. The plurality of resources 30a-30n may comprise network resources being implemented in the virtualized environment 50. Examples of the network resources may include, but are not limited to, containers 30a, virtual interfaces 30b for the containers 30a, virtual switches/Dockers 30c connected to the containers 30a, virtual interfaces 30d and 30e for the virtual switches 30c, and so on. The containers 30a referred herein may be virtualized computing instances adapted to execute the one or more applications 10a-102n. The virtual interfaces 30b may represent egress ports of the containers 30a. The virtual switches 30c may be adapted to route packets/data stream from the containers 30a to a physical interface 55 on the computing device 60, wherein the packets are generated during execution of the one or more applications on the containers 30a. In some examples, the physical interface 55 on the computing device 60 may be a Network Interface Card, NIC, being connected to one or more Ethernet ports on the computing device 60. The virtual interfaces 30d and 30e may represent ingress ports and egress ports of the virtual switches 30c, respectively. In some examples, the virtual interfaces 30b of the containers 30a, and the virtual interfaces 30d and 30e of the virtual switches 30c may comprise Ethernet ports. It should be understood that any other network resources including the above-described may be implemented in the virtualized environment 50.

In some examples, the computing resources may include Operating System, OS, resources or resources of kernel (referred to as the kernel resources) 30n in the computing device 60. In some examples, the computing resources may include, but are not limited to, system processes (queue handling), libraries, and so on. In some examples, the computing resources may include, but are not limited to, processors/Central Processing Unit, CPU, memory, Input/output devices, file storage, and so on.

According to embodiments disclosed herein, the computing device 60 comprises a virtual resource configurator, VRC 40 within the virtualized environment 50. The VRC 40 is configured to schedule the plurality of applications for execution in the virtualized environment 50.

For scheduling the plurality of applications 10a-10n, the VRC 40 obtains deterministic characteristics for each application of the plurality of applications comprising one or more instances and configuration information related to the plurality of resources 30a-30n of the computing device 60 for execution of the plurality of applications.

In some examples, the VRC 40 may obtain the deterministic characteristics for each application and the configuration information from the CUC 95 of the TSN system 100.

The deterministic characteristics obtained for each application may indicate deterministic service requirements of the application that involve guaranteed time synchronisation, precise end-to-end, E2E, timeliness, high reliability, low jitter, and low latency. In some examples, the deterministic characteristics obtained for each application may comprise one or more of: time sensitive characteristics for each application, latency characteristics for each application, priority characteristics for each application, and reliability requirements for each application. For example, the time sensitive characteristics obtained for the application may identify whether the application is a time sensitive application requiring deterministic schedule from application-aware control/management entity, such as the TSN CNC 90. Similarly, the reliability requirements for the application may identify how tolerant the application is to unsuccessful packet deliver, jitter, or the like.

Thus, from the obtained deterministic characteristics, the VRC 40 may identify time sensitive applications, applications that have requirement of data/packet traffic handling, applications that do not have any deterministic service requirements (may be referred to as best effort service), or the like.

In some examples, the configuration information related to the plurality of resources 30a-30n may comprise one or more of: information about a topology of the plurality of resources 30a-30n , information availability of the plurality of resources 30a-30n , and latency information related to the plurality of resources 30a-30n (i.e., latency characteristics of the plurality of resources 30a-30n).

Based on the deterministic characteristics and the configuration information, the VRC 40 allocates at least some resources from the plurality of resources to each of the plurality of applications 10a-10n. In some examples, allocating at least some resources to each of the plurality of applications 10a-10n may involve allocating/reserving specific amount/quantity of resources for each of the plurality of applications 10a-10n.

For allocating at least some resources to each application, the VRC 40 may divide the plurality of applications 10a-10n into groups according to the deterministic characteristics obtained for each of the plurality of applications 10a-10n. For example, consider that the VRC 40, from the obtained deterministic characteristics for each application, identify that the plurality of applications 10a-10n may include time sensitive applications, applications requiring high reliability, applications requiring low latency, and best effort services. In such a scenario, the VRC 40 may divide the time sensitive applications into a first group, the applications requiring high reliability into a second group, the applications requiring low latency into a third group, and the best effort services into a fourth group.

Upon grouping of applications, the VRC 40 may select at least some resources from the plurality of resources 30a-30n for each group. For selecting the at least some resources, the VRC 40 may associate namespaces of the kernel in the computing device 60 to the groups of applications. In some examples, the namespaces of the kernel may comprise process identifiers, IDs, of the kernel. Associating the namespaces for the groups of applications may ensure kernel namespaces (i.e., kernel resources) separation between different (types and instances of) applications. Thereafter, the VRC 40 may identify, for each namespace, the deterministic characteristics for the associated group of applications. Based on the deterministic characteristics and configuration information related to the plurality of resources 30a-30n, the VRC 40 may select at least some resources for each of the namespaces. As a result, a namespace associated with one group of applications may identify at least some resources allocated to that namespace, but not a resource allocated to another namespace associated with another group of applications. Thereby, ensuring effective resource separation between the different applications.

In an example, consider that a namespace is associated to a group of applications that comprise time sensitive applications. In such a scenario, the VRC 40 may select a resource like system processes (for example, queue management, traffic control) related to the time sensitive application to the namespace by ensuring time guarantees for the system processes in the kernel space. The VRC 40 may also select a dedicated CPU to the namespace associated with the time sensitive applications and related system processes. Thus, linking the time sensitive applications and the related system processes to the same CPU.

In another example, the VRC 40 may select a resource like a virtual switch having dedicated resources for the namespace associated with the time sensitive applications.

In some examples, the VRC 40 may also consider the priority characteristics obtained for applications to further tune/refine selection of at least some resources for the namespace associated with the corresponding applications.

Thus, selection of at least some resources for each namespace based on the deterministic characteristics and configuration information may increase resource isolation between concurrent applications.

Upon selecting at least some resources for each namespace, the VRC 40 may allocate at least some resources for each namespace based upon the selection.

In accordance with the allocation of at least some resources, the VRC 40 schedules the plurality of applications 10a-10n on the plurality of resources 10a-10n for execution in the virtualized environment.

For scheduling the plurality of applications 10a-10n, the VRC 40 may identify the groups of applications and the namespace associated with each group of applications. Each group may comprise at least one application. The VRC 40 may determine at least some resources allocated for each group of applications according to the namespace associated with each group of applications. The VRC 40 may schedule each group of applications on the determined at least some resources for execution in the virtualized environment 50. Thus, resulting in coordinated scheduling of applications for execution in the virtualized environment 50. The coordinated scheduling may eliminate a need for the applications to wait for the resources. In addition, the coordinated scheduling may enable packets generated during execution of the applications in the virtualized environment 50 to reach the physical interface 55 on the computing device 60 within a time interval configured by the CNC 90 of the TSN system 100. Thus, guaranteeing precise E2E timeliness.

In some embodiments, the VRC 40 may modify scheduling of the at least one application during execution in the virtualized environment 50. The VRC 40 may monitor execution of the scheduled plurality of applications within the virtualized environment 50. Based on the monitoring, the VRC 40 may determine degradation in performance of the at least one application of the plurality of applications 10a-10n. In some examples, the VRC 40 may receive information about degradation from an application domain. Upon determining degradation in performance of the at least one application, the VRC 40 may modify allocation of the at least some resources for the at least one application. In accordance with the modified allocation, the VRC 40 may schedule the at least one application for execution in the virtualized environment 50.

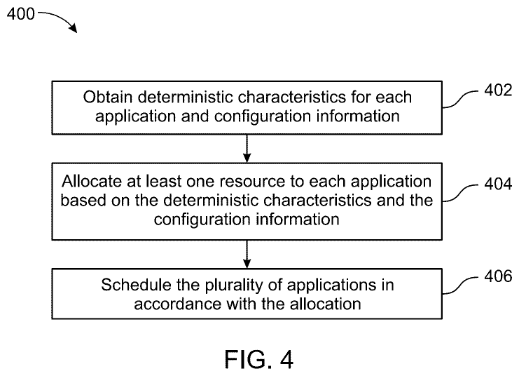

FIG. 4 is a flowchart illustrating example method steps of a method 400 performed for scheduling the plurality of applications for execution in the virtualized environment resident on the computing device. The computing device is operated as the TSN entity for the TSN system integrated to the wireless communication network. The method 400 is performed within the virtualized environment by the computing device.

At step 402, the method 400 comprises obtaining deterministic characteristics for each application of the plurality of applications comprising one or more instances and configuration information related to the plurality of resources of the computing device for execution of the plurality of applications. In some examples, the deterministic characteristics and the configuration information may be obtained from the CUC of the TSN system.

In some examples, the deterministic characteristics obtained for each application identify deterministic service requirements of the application. In some examples, the deterministic characteristics obtained for each application may comprise one or more of: time sensitive characteristics, latency characteristics, priority characteristics, and reliability requirements obtained for each application.

In some examples, the configuration information may comprise one or more of: information about topology, latency information and availability of the plurality of resources.

At step 404, the method 400 comprises allocating at least some resources from the plurality of resources to each of the plurality of applications based on the deterministic characteristics and the configuration information. In some examples, the plurality of resources may comprise one or more of: network resources being implemented within the virtualized environment and computing resources of the computing device. In some examples, allocating at least some resources to each of the plurality of applications 10a-10n may involve allocating/reserving specific amount/quantity of resources for each of the plurality of applications 10a-10n.

In some embodiments, the step 404 of allocating at least some resources of from the plurality of resources to each of the plurality of applications may comprise dividing the plurality of applications into groups, each group comprising at least one application, according to the deterministic characteristics for each of the plurality of applications. Thus, the applications having the same deterministic characteristics may be present in the same group and the applications having the different deterministic characteristics may be present in different groups. Upon dividing the plurality of applications, the method may comprise selecting at least some resources from the plurality of resources for each group of applications.

In some embodiments, the step of selecting at least some resources from the plurality of resources for each group of applications may comprise associating namespaces of a kernel in the computing device to the groups of applications. In some examples, the namespaces of the kernel may be process IDs of the kernel. The namespaces may be associated to the groups of applications in order to ensure kernel resource separation between different types and instances of applications. The method may comprise identifying, for each namespace, the deterministic characteristics for the associated group of applications. Based on the deterministic characteristics and the configuration information, the method may comprise selecting at least some resources for each of the namespaces. Such a resource selection may increase resource isolation between the applications identified to be executed concurrently in the virtualized environment and may eliminate a waiting time of applications for the resources.

Based upon selection, the method may comprise allocating at least some resources from the plurality of resources for each group of applications. Herein, allocating at some resources for each group of applications may refer to allocating at least some resources for each of the namespaces associated with the groups of applications.

In accordance with the allocation, at step 406, the method 400 comprises scheduling the plurality of application on the plurality of resources.

In some embodiments, the step 406 of scheduling the plurality of application on the plurality of resources may comprise identifying groups of applications, and a namespace associated with each group of applications. The method may comprise determining at least some resources allocated for each group of applications according to the namespace associated with each group of applications. The method may comprise scheduling each group of applications on the determined at least some resources for execution in the virtualized environment. Thus, resulting in coordinated scheduling of the plurality of applications.

Optionally, the method 400 may further comprise monitoring execution of the scheduled plurality of applications within the virtualized environment. Based on the monitoring, the method may comprise determining degradation in performance of the at least one application of the plurality of applications. Upon determining degradation in performance of the at least one application, the method may comprise modifying allocation of the at least some resources for the at least one application. In accordance with the modified allocation, the method may comprise scheduling the at least one application for execution in the virtualized environment.

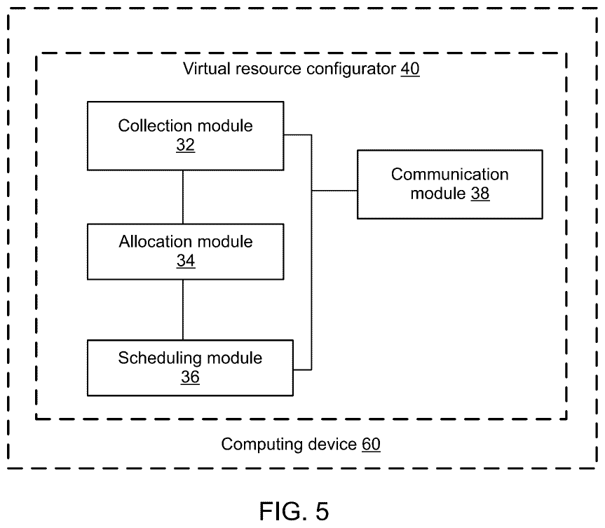

FIG. 5 is an example schematic block diagram showing functional modules of the VRC 40 being executed on the computing device 60. The computing device 60 is operated as a TSN entity for the TSN system integrated to the wireless communication network.

As depicted in FIG. 5, the VRC 40 may include one or more modules configured to cooperate with each other for scheduling the plurality of applications for execution within the virtualized environment. For example, the VRC 40 may include a collection module 32, an allocation module 34, a scheduling module 36, and a communication module 38.

The communication module 38 may be configured to enable the VRC 40 to communicate with the CUC of the TSN system.

The collection module 32 may be configured to obtain, from the CUC through the communication module 38, deterministic characteristics for each application of the plurality of applications and configuration information related to the plurality of resources of the computing device 60.

The allocation module 34 may be configured to allocate at least some resources from the plurality of resources for each application, based on the deterministic characteristics and the configuration information. The allocation module 34 may also be configured to modify allocation upon determining degradation in performance of the at least one application during execution in the virtualized environment.

The scheduling module 36 may be configured to schedule the plurality of application on the plurality of resources for execution in the virtualized environment in accordance with the allocation. The scheduling module 36 may also be configured to schedule the at least one application in accordance with the modified allocation.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

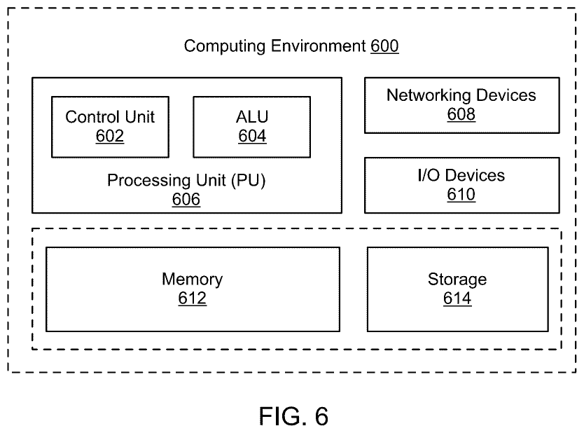

FIG. 6 illustrates an example computing environment 600 implementing a method and the apparatus, as described in FIGS. 4 and 3. As depicted in FIG. 6, the computing environment 600 comprises at least one data processing module 606 that is equipped with a control module 602 and an Arithmetic Logic Unit (ALU) 604, a plurality of networking devices 608 and a plurality Input output, I/O devices 610, a memory 612, a storage 614. The data processing module 606 may be responsible for implementing the method described in FIG. 4. For example, the data processing module 606 may in some embodiments be equivalent to the VRC/CPU/processor/controller of the computing device described above in conjunction with the FIG. 3. The data processing module 606 is capable of executing software instructions stored in memory 612. The data processing module 606 receives commands from the control module 602 in order to perform its processing. Further, any logical and arithmetic operations involved in the execution of the instructions are computed with the help of the ALU 604.

The computer program is loadable into the data processing module 606, which may, for example, be comprised in an electronic apparatus (such as a computing device). When loaded into the data processing module 606, the computer program may be stored in the memory 612 associated with or comprised in the data processing module 606. According to some embodiments, the computer program may, when loaded into and run by the data processing module 606, cause execution of method steps according to, for example, any of the method illustrated in FIG. 4 or otherwise described herein.

The overall computing environment 600 may be composed of multiple homogeneous and/or heterogeneous cores, multiple CPUs of different kinds, special media and other accelerators. Further, the plurality of data processing modules 606 may be located on a single chip or over multiple chips.

The algorithm comprising of instructions and codes required for the implementation are stored in either the memory 612 or the storage 614 or both. At the time of execution, the instructions may be fetched from the corresponding memory 612 and/or storage 614, and executed by the data processing module 606.

In case of any hardware implementations various networking devices 608 or external I/O devices 610 may be connected to the computing environment to support the implementation through the networking devices 608 and the I/O devices 610.

The embodiments disclosed herein can be implemented through at least one software program running on at least one hardware device and performing network management functions to control the elements. The elements shown in FIG. 6 include blocks which can be at least one of a hardware device, or a combination of hardware device and software module.

1. A method for scheduling a plurality of applications for execution in a virtualized environment resident on a computing device, the computing device being operated as an entity for a TSN system, the TSN system being integrated to a wireless communication network, the method being performed within the virtualized environment by the computing device, the method comprising:
obtaining deterministic characteristics for each application of the plurality of applications comprising one or more instances and configuration information related to a plurality of resources of the computing device for execution of the plurality of applications;
allocating at least some resources from the plurality of resources to each of the plurality of applications based on the deterministic characteristics and the configuration information; and
scheduling the plurality of applications on the plurality of resources in accordance with the allocation.

2. The method according to claim 1, wherein the step of allocating at least some resources from the plurality of resources to each of the plurality of applications comprises:
dividing the plurality of applications into groups, each group comprising at least one application, according to the deterministic characteristics for each of the plurality of applications;
selecting at least some resources from the plurality of resources for each group of applications; and
allocating at least some resources from the plurality of resources for each group of applications based upon the selection.

3. The method according to claim 2, wherein the step of selecting at least some resources from the plurality of resources for each group of applications comprises:
associating namespaces of a kernel in the computing device to the groups of applications;
identifying, for each namespace, the deterministic characteristics for the associated group of applications; and
selecting, based on the deterministic characteristics and the configuration information, at least some resources for each of the namespaces.

4. The method according to claim 1, wherein the deterministic characteristics obtained for each application comprises one or more of:
time sensitive characteristics for each application;
latency characteristics for each application;
priority characteristics for each application; and
reliability requirements for each application.

5. The method according to claim 1, wherein the configuration information related to the plurality of resources comprises one or more of:
information about deployment details of the plurality of resources;
information about availability of the plurality of resources; and
latency information related to the plurality of resources.

6. The method according to claim 1, wherein the step of scheduling the plurality of applications comprises:
identifying groups of applications, and a namespace associated with each group of applications;
determining at least some resources allocated for each group of applications according to the namespace associated with each group of applications; and
scheduling each group of applications on the determined at least some resources for execution in the virtualized environment.

7. The method according to claim 1, wherein the plurality of resources comprises one or more of:
network resources being implemented within the virtualized environment; and
computing resources of the computing device.

8. The method according to claim 1, further comprising:
monitoring execution of the scheduled plurality of applications in the virtualized environment;
determining, based on the monitoring, degradation in performance of the at least one application of the plurality of applications;
modifying allocation of the at least some resources for the at least one application upon determining degradation in performance of the at least one application; and
scheduling the at least one application in accordance with the modified allocation.

9. A computing device for scheduling a plurality of applications for execution in a virtualized environment resident on the computing device, the computing device being operated as an entity for a TSN system, the TSN system being integrated to a wireless communication network, the computing device being adapted for:
obtaining deterministic characteristics for each application of the plurality of applications comprising one or more instances and configuration information related to a plurality of resources of the computing device for execution of the plurality of applications;
allocating at least some resources from the plurality of resources to each of the plurality of applications based on the deterministic characteristics and the configuration information; and
scheduling the plurality of applications on the plurality of resources in accordance with the allocation.

10. The computing device according to claim 9, wherein the computing device is being adapted for allocating at least some resources from the plurality of resources to each of the plurality of applications by:
dividing the plurality of applications into groups, each group comprising at least one application, according to the deterministic characteristics for each of the plurality of applications;
selecting at least some resources from the plurality of resources for each group of applications; and
allocating at least some resources from the plurality of resources for each group of applications based upon the selection.

11. The computing device according to claim 10, wherein the computing device is being adapted for selecting at least some resources from the plurality of resources for each group of applications by:
associating namespaces of a kernel in the computing device to the groups of applications;
identifying, for each namespace, the deterministic characteristics for the associated group of applications; and
selecting, based on the deterministic characteristics and the configuration information, at least some resources for each of the namespaces.

12. The computing device according to claim 9, wherein the deterministic characteristics obtained for each application comprises one or more of:
time sensitive characteristics for each application;
latency characteristics for each application;
priority characteristics each application; and
reliability requirements for each application.

13. The computing device according to claim 9, wherein the configuration information related to the plurality of resources comprises one or more of:
information about a topology of the plurality of resources;
information about availability of the plurality of resources; and
latency information related to the plurality of resources.

14. The computing device according to claim 9, wherein the computing device is being adapted for scheduling the plurality of applications by:
identifying groups of applications, and a namespace associated with each group of applications;
determining the at least some resources allocated for each group of applications according to the namespace associated with each group of applications; and
scheduling each group of applications on the determined at least some resources for execution in the virtualized environment.

15. The computing device according to claim 9, wherein the plurality of resources comprises one or more of:
network resources being implemented within the virtualized environment; and
computing resources of the computing device.

16. The computing device according to claim 9, wherein the computing device is being adapted for:
monitoring execution of the scheduled plurality of applications in the virtualized environment;
determining, based on the monitoring, degradation in performance of the at least one application of the plurality of applications;
modifying allocation of the at least some resources for the at least one application upon determining degradation in performance of the at least one application; and
scheduling the at least one application in accordance with the modified allocation.

17. A non-transitory computer readable medium having thereon a computer program comprising program instructions, the computer program being loadable into a data processing unit and configured to cause execution of the method according to claim 1 when the computer program is run by the data processing unit.
